(19) United States
(12) Patent Application Publication
(10) Pub. No.: US 2006/0114224 A1
(43) Pub. Date: Jun. 1, 2006

(54) Electronic apparatus, input control apparatus, and input control program storage medium

(75) Inventor: Junichi Ninomiya, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/050,023

(22) Filed: Feb. 4, 2005

(30) Foreign Application Priority Data
Nov. 29, 2004 (JP) 2004-344425

(51) Int. Cl. G09G 5/00; G09G 5/08

(52) U.S. Cl. 345/157; 345/173

(57) ABSTRACT

An electronic apparatus moves a cursor to a desired position with simple operation using a few operation members. The apparatus includes a display section which displays an information screen within a display area, and an operation section in which a pointing device operable in an arbitrary direction and direction keys respectively assigned predetermined directions are installed. In the operation section, the pointing device moves an input position within the display area in a direction associated with an operation, and the direction keys shift a cell selected from among cells, into which the display area is divided, in a direction associated with an operation among the predetermined directions and move the input position into the selected cell shifted. When the selected cell is moved by the direction key, an input position moves roughly. When the selected cell is moved by operating the pointing device, the input position moves finely.

### BACKGROUND OF THE INVENTION

1. Field of the Invention

The present invention relates to an electronic apparatus which displays an information screen and accepts command or information input on the information screen, an input control apparatus which performs input control in the electronic apparatus, and an input control program storage medium which stores an input control program to be executed in the electronic apparatus.

2. Description of the Related Art

Conventionally, there is known an electronic apparatus, such as a portable information terminal or mobile phone, having a display which displays an information screen and input means for inputting information or commands on the information screen. Such an electronic apparatus will be generically referred to as an information display/input apparatus hereinafter. In the information display/input apparatus, a cursor indicating an input position on the information screen is also displayed on the display. The information display/input apparatus further includes operation means for moving the cursor through operation and an input control apparatus.

As an example of the operation means, there is known a cross key which moves the cursor between input positions fixed on the information screen. There are also known a pointing device which can be operated in an arbitrary direction and moves the cursor in a direction associated with an operation. There is also known a touch panel which, by touching the information screen, can move the cursor to the touched position of the information screen. The cross key or pointing device is mainly provided in a mobile phone while the touch panel is mainly provided in a portable information terminal.

Although the cross key is effective in moving the cursor stepwise from one of fixed input positions to another, the information screen needs to be adapted to a method for moving the cross key.

In the case of the pointing device, in contrast, the information screen has a high degree of flexibility in the arrangement. However, it is difficult to align the cursor at an intended position on a modern display with an increased size and higher resolution. The flexibility in the screen arrangement is not compatible with easy operability.

The touch panel is very effective in moving the cursor to an intended position. However, a film-like sensor mounted on the display impairs the visibility, and the touch panel cannot be used with one hand. In the display with an increased resolution, since a target position falls within a very small area, it is difficult to reliably select the specific small area.

To cope with the present circumstances, there is proposed a cursor movement method in which grid cells formed by dividing the display area of a display are made to correspond to the positions of the respective keys of a numeric keypad, a grid cell is selected by depressing a corresponding key of the numeric keypad, a cursor is moved into the grid cell, and the cursor is moved using a pointing device as described above or the like (see, e.g., Japanese Patent Laid-Open No. 63-311519, Japanese Patent Laid-Open No. 2-204787, and Japanese Patent Laid-Open No. 2002-14773).

However, the technique described in each of the patent references essentially requires a numeric keypad as a piece of hardware. In the case of an apparatus such as a portable information terminal which is not generally equipped with a numeric keypad, it is difficult to find space for a numeric keypad. In a mobile phone, a cross key or pointing device is often separated from a numeric keypad by a certain distance for the convenience of dial operation and the like. To use both the devices with one hand, fingers need to be moved largely, which impairs the operability.

### SUMMARY OF THE INVENTION

The present invention has been made in view of the above circumstances and provides an electronic apparatus, input control apparatus, and input control program storage medium which freely moves an input position with simple operation using a few operation members to allow the input.

An electronic apparatus according to the present invention is

an electronic apparatus which displays an information screen and accepts input on the displayed information screen, the apparatus including

a display section which displays an information screen within a display area, and

an operation section in which a pointing device operable in an arbitrary direction and direction keys respectively assigned predetermined directions are installed, the pointing device moving an input position within the display area in a direction associated with an operation, the direction keys shifting a cell selected from among cells, into which the display area is divided, in a direction associated with an operation among the predetermined directions and moving the input position into the selected cell shifted.

According to the electronic apparatus of the present invention, a selected cell is moved by operating a few direction keys such as a cross key and the like, thereby implementing rough movement of an input position. By operating a pointing device (generally only one is provided), fine movement of the input position is implemented. Thus, the input position can be freely moved. These operation members including the direction keys and pointing device can be operated easily with one hand.

Preferably, in the electronic apparatus of the present invention, the direction keys are so arranged as to surround the pointing device.

According to this preferred electronic apparatus, the pointing device and direction keys are compactly arranged. This facilitates operation.

Preferably, in the electronic apparatus of the present invention, a cell change operation member which changes the cells, into which the display area is divided, to cells associated with an operation is also installed in the operation section.

According to this preferred electronic apparatus, the cell change operation member changes the form of the cells. This makes it possible to select a form suitable for an operation of moving an input position.

An input control apparatus according to the present invention is

an input control apparatus for performing input control in an electronic apparatus which displays an information screen and accepts input on the displayed information screen,

wherein the electronic apparatus includes a display section which displays an information screen within a display area, and an operation section in which a pointing device operable in an arbitrary direction and direction keys respectively assigned predetermined directions are installed, and

the input control apparatus includes

an input position control section which moves an input position within the display area in a direction associated with an operation of the pointing device, and

a selected cell control section which shifts a cell selected from among cells, into which the display area is divided, in a direction associated with an operation of the direction key among the predetermined directions and moves the input position into the selected cell shifted.

According to the input control apparatus of the present invention, free input with simple operation as described above can be implemented.

An input control program storage medium according to the present invention is

a storage medium storing an input control program executed by an electronic apparatus which displays an information screen and accepts input on the displayed information screen,

wherein the electronic apparatus includes a display section which displays an information screen within a display area, and an operation section in which a pointing device operable in an arbitrary direction and direction keys respectively assigned predetermined directions are installed, and

the input control program constructs, on the electronic apparatus,

an input position control section which moves an input position within the display area in a direction associated with an operation of the pointing device, and

a selected cell control section which shifts a cell selected from among cells, into which the display area is divided, in a direction associated with an operation of the direction key among the predetermined directions and moves the input position into the selected cell shifted.

According to the input control apparatus of the present invention, components of the input control apparatus of the present invention can be implemented.

In the above explanation, only basic features of an input control apparatus and input control program according to the present invention are described. This merely aims at avoiding repetition. The input control apparatus and input control program according to the present invention take not only such basic features but also various features corresponding to the features of the above electronic apparatus.

As described above, according to the electronic apparatus, input control apparatus, and input control program storage medium of the present invention, a cursor can be moved to a desired position with simple operation using a few operation members.

### BRIEF DESCRIPTION OF THE DRAWINGS

FIG. 1 is a view of the outer appearance of a portable information terminal according to an embodiment of an electronic apparatus according to the present invention;

FIG. 2 is a diagram of the hardware configuration of the portable information terminal;

FIG. 3 is a diagram showing an input control program;

FIG. 4 is a functional block diagram of the portable information terminal;

FIG. 5 is a display example on an LCD; and

FIG. 6 is a flowchart showing the operation of the portable information terminal in a grid mode.

### DETAILED DESCRIPTION OF THE INVENTION

An embodiment of the present invention will be explained below with reference to the drawings.

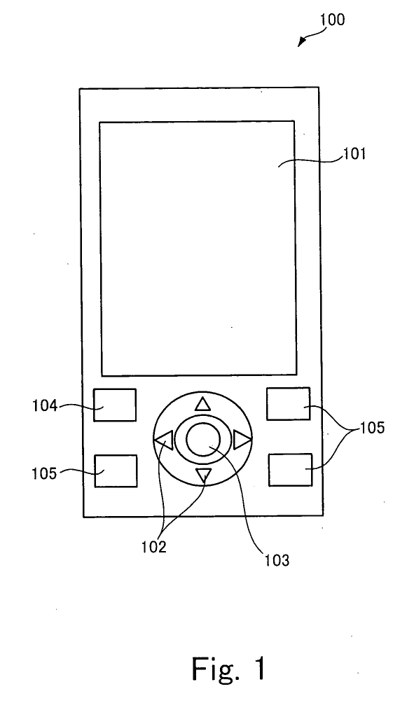

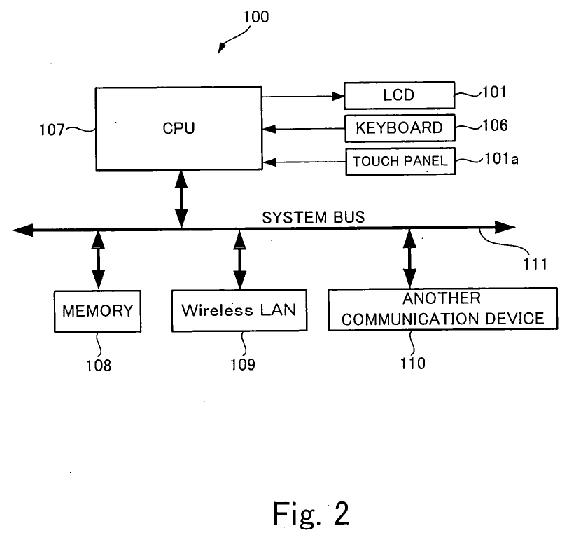

FIG. 1 is a view of the outer appearance of a portable information terminal according to an embodiment of the electronic apparatus of the present invention. FIG. 2 is a diagram of the hardware configuration of the portable information terminal.

As shown in FIG. 1, a portable information terminal 100 has, on the outside, an LCD (Liquid Crystal Display) 101 on which an information screen and cursor are displayed, a cross key 102 which can be depressed so as to correspond to each of the four directions (upward, downward, left, and right directions), a pointing device 103 which can be slid in an arbitrary direction in a plane parallel to FIG. 1, a grid cell display key 104 which switches the operation mode to a grid mode (to be described later) in which grid cells are displayed, and other keys 105. The cross key 102 is so arranged as to surround the pointing device 103, and a touch panel is provided on the display surface of the LCD 101.

As shown in FIG. 2, the portable information terminal 100 incorporates a CPU 107, to which the LCD 101 and a touch panel 101a are connected. A keyboard 106 having the cross key 102 and pointing device 103 is also connected to the CPU 107. The LCD 101 is an example of the display section of the present invention; the keyboard 106, an example of the operation section of the present invention; the cross key 102, an example of the direction key of the present invention; and the pointing device 103, an example of the pointing device of the present invention.

The portable information terminal 100 further incorporates a memory 108 which stores a program or data used by the CPU 107, a wireless LAN device 109 to be connected to a LAN (Local Area Network), and another communication device 110 to be connected to another portable information terminal, personal computer, or the like. These components and the CPU 107 are connected to each other through a system bus 111.

The portable information terminal 100 is an apparatus which displays an information screen on the LCD 101 and accepts information or command input on the information screen. The portable information terminal 100 displays an image screen, a menu screen, a window, a screen on which icons are placed, and the like as information screens. The cursor displayed on the LCD 101 indicates an input position for information or a command. The following explanation may make no distinction between the term “input position” and the term “cursor.”

The pointing device 103 is an operation member used specifically to move the cursor displayed on the LCD 101. The cross key 102 is an operation member used to, e.g., select a menu item on an information screen displayed on the LCD 101 and is also used as an operation member which moves a selected grid cell in the grid mode (to be described later) The other keys 105 are used to, e.g., confirm a selected menu item and click an icon. The touch panel on the LCD 101 is used for various types of operations such as moving the cursor, selecting and confirming a menu item, and clicking an icon.

As described above, the portable information terminal 100 according to this embodiment includes the touch panel. The touch panel generally requires operation with both hands. Since each button of a window displayed on the high-resolution LCD 101 is very small, it is sometimes difficult to move the cursor onto the small button. For this reason, the portable information terminal 100 of this embodiment is designed in a manner (to be explained below) such that the cursor can be freely moved with simple operation with one hand using the cross key 102 and pointing device 103.

The memory 108 of the portable information terminal 100 is an embodiment of the input control program storage medium according to the present invention and stores an input control program. When the input control program is executed by the CPU 107, a motherboard on which the CPU 107 is mounted functions as an embodiment of the input control apparatus according to the present invention. The portable information terminal 100 functions as an embodiment of the electronic apparatus according to the present invention.

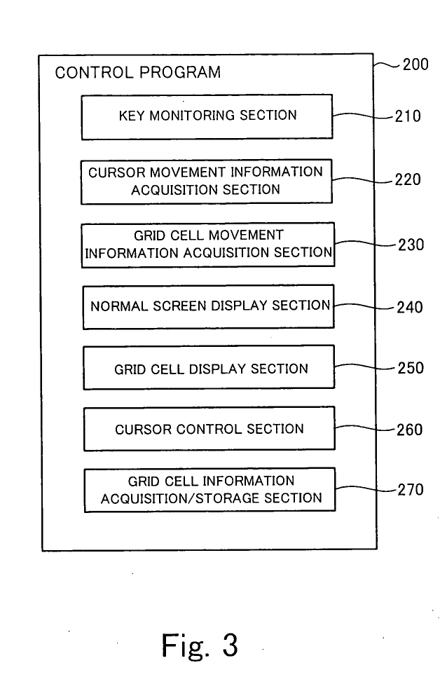

FIG. 3 is a diagram showing an input control program.

An input control program 200 shown in FIG. 3 is composed of a key monitoring section 210, cursor movement information acquisition section 220, grid cell movement information acquisition section 230, normal screen display section 240, grid cell display section 250, cursor control section 260, and grid cell information acquisition/storage section 270. The components of the input control program 200 will be described later.

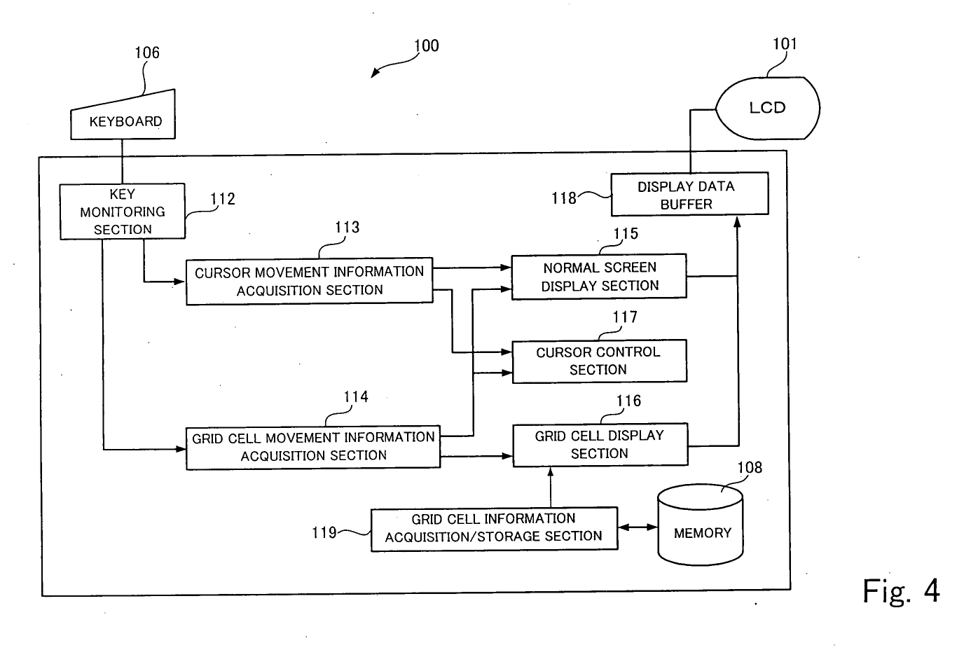

FIG. 4 is a functional block diagram of the portable information terminal.

The functional block diagram shows functional components related to cursor control. Note that portions related to the touch panel are omitted.

The portable information terminal 100 includes a key monitoring section 112 which monitors operation of the grid cell display key, cross key, and pointing device installed in the keyboard 106, a cursor movement information acquisition section 113 which acquires cursor movement information from the key monitoring section 112, a grid cell movement information acquisition section 114 which acquires grid cell movement information from the key monitoring section 112, a normal screen display section 115 which controls the display of the information screens and cursor, a grid cell display section 116 which controls the display of the grid cells, a cursor control section 117 which manages the cursor as an input position, a display data buffer 118 which holds display data describing a screen to be displayed on the LCD 101, and a grid cell information acquisition/storage section 119 which accesses the memory 108 to acquire/store basic information for grid cell display from/in the memory 108.

Out of these functional components, the key monitoring section 112, cursor movement information acquisition section 113, grid cell movement information acquisition section 114, normal screen display section 115, grid cell display section 116, cursor control section 117, and grid cell information acquisition/storage section 119 are respectively constructed by the key monitoring section 210, cursor movement information acquisition section 220, grid cell movement information acquisition section 230, normal screen display section 240, grid cell display section 250, cursor control section 260, and grid cell information acquisition/storage section 270 shown in FIG. 3 upon execution of the input control program 200 shown in FIG. 3 by the CPU 107 shown in FIG. 2. That is, the components shown in FIG. 3 correspond to those shown in FIG. 4.

Out of the functional components shown in FIG. 4, the key monitoring section 112, cursor movement information acquisition section 113, normal screen display section 115, and cursor control section 117 constitute an example of the input position control section of the present invention. The key monitoring section 112, grid cell movement information acquisition section 114, grid cell display section 116, cursor control section 117, and grid cell information acquisition/storage section 119 constitute an example of the selected cell control section of the present invention. The key monitoring section 112 and grid cell display section 116 constitute an example of the cell change control section of the present invention.

Cursor movement operations to be implemented by the functional components shown in FIG. 4 are divided into ones in a normal mode and ones in the grid-mode.

In the normal mode, in response to an operation of the pointing device, the cursor movement information acquisition section 113 acquires cursor movement information from the key monitoring section 112 and sends it to the normal screen display section 115 and cursor control section 117. On the basis of the cursor movement information, the cursor and input position are moved.

The grid mode starts when the grid cell display key in the keyboard 106 is depressed. In the grid mode, in response to an operation of the cross key, the grid cell movement information acquisition section 114 acquires grid cell movement information from the key monitoring section 112 and sends it to the normal screen display section 115, grid cell display section 116, and cursor control section 117. On the basis of the grid cell movement information, the grid cells, cursor, and input position are moved.

Cursor movement operation will be explained below with reference to a display example on the LCD and a flowchart. In the following explanation, the components shown in the functional block diagram of FIG. 4 will be referred to only by reference numerals without referring to the drawing's number.

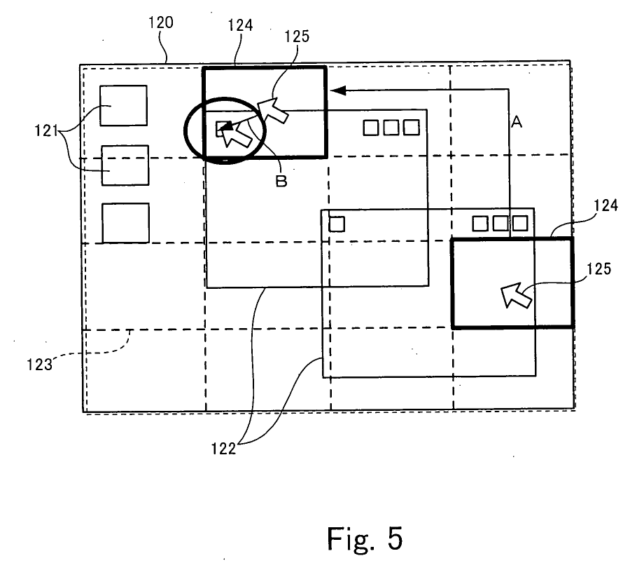

FIG. 5 illustrates a display example on the LCD.

On a display area 120 of the LCD, a desktop screen on which icons 121 are placed, a window 122, and the like are displayed as information screens of the present invention. An arrow-shaped cursor 125 indicating the input position on an information screen is also displayed in the display area 120. The cursor 125 moves in accordance with an operation of the pointing device 103 shown in FIG. 1. If a click operation is performed when the cursor 125 is located on one of the icons 121 or a button of the window 122, an instruction corresponding to the button or icon 121 pointed to with the cursor 125 and others are executed.

When the grid cell display key 104 shown in FIG. 1 is depressed, the grid cells 123 into which the display area 120 is divided is displayed in the display area 120. The operation of the portable information terminal shifts to the grid mode.

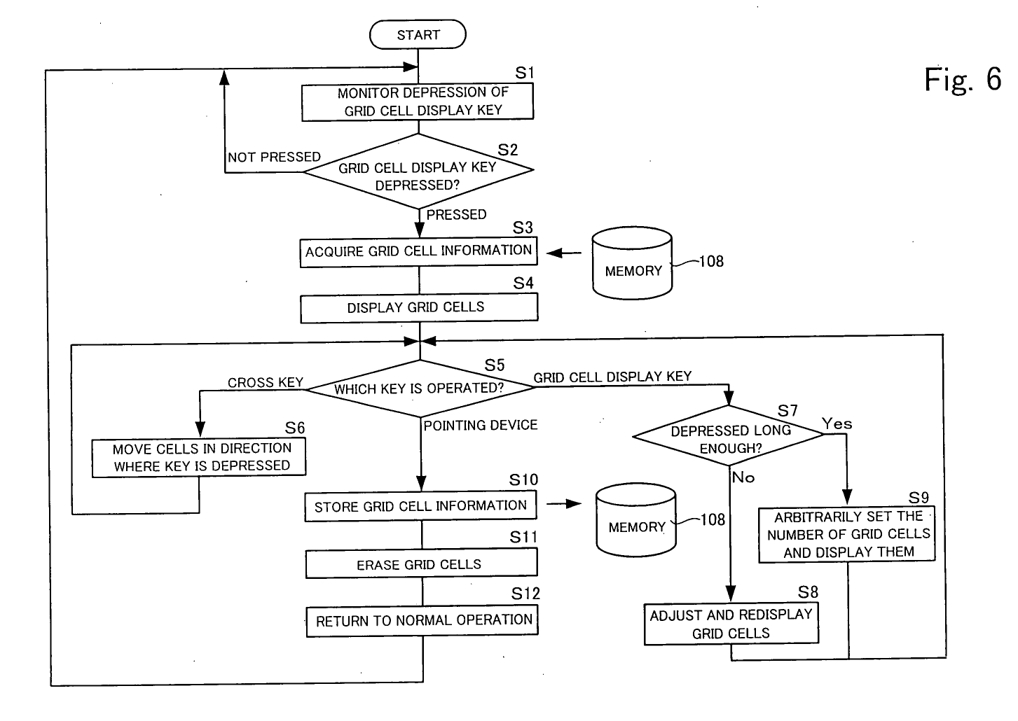

FIG. 6 is a flowchart showing the operation of the portable information terminal in the grid mode.

A shift to the grid mode will be described. The key monitoring section 112 is monitoring the grid cell display key for any depression (step S1). When the grid cell display key is depressed (PRESSED in step S2), the grid cell information acquisition/storage section 119 acquires basic information such as the number of grid cells from the memory 108 (step S3) and passes it to the grid cell display section 116. On the basis of the basic information, the grid cell display section 116 supplies display data to display the grid cells 123 in the display area 120, as shown in FIG. 5, to the display data buffer 118, and the grid cells are displayed on the LCD 101 (step S4). The grid cell display section 116 also supplies display data to display a grid cell containing an input position pointed to with the cursor 125 at this time as a selected grid cell 124, as shown in FIG. 5, to the display data buffer 118, and the selected grid cell 124 is also displayed on the LCD 101.

Then, the key monitoring section 112 starts monitoring the keyboard 106 to determine which key is operated (step S5). If the cross key 102 shown in FIG. 1 is depressed, the flow advances to step S6. In step S6, the grid cell movement information acquisition section 114 acquires the direction in which the cross key 102 is depressed as information indicating the moving direction of the grid cells from the key monitoring section 112 and passes it to the normal screen display section 115, grid cell display section 116, and cursor control section 117. The grid cell display section 116 supplies display data to move the selected grid cell 124 in the moving direction indicated by the information, as indicated by, e.g., an arrow A in FIG. 5, to the display data buffer 118. The normal screen display section 115 supplies, to the display data buffer 118, display data to move the cursor 125 together with the selected grid cell 124. The cursor control section 117 manages, as the input position, the position of the cursor after the movement. After these processes in step S6, the flow returns to step S5. In step S5, the key monitoring section 112 restarts monitoring the keyboard 106 continuously.

When the grid cell display key 104 shown in FIG. 1 is depressed in step S5, the flow advances to step S7 to determine whether the grid cell display key 104 is depressed long enough. If the grid cell display key 104 is depressed for a short time, the grid cell display section 116 increases each of the number of grid cells per row and that of grid cells per column in the basic information by one and supplies display data to renew the display with the increased grid cells to the display data buffer 118 (step S8). On the other hand, if it is determined in step S7 that the grid cell display key 104 is depressed long enough, the grid cell display section 116 displays a setup screen (not shown) on the LCD and causes the user to arbitrarily set each of the number of grid cells per row and that of grid cells per column through the setup screen. The grid cell display section 116 updates the basic information in accordance with the number of grid cells set through the setup screen and supplies display data to display the set number of grid cells to the display data buffer 118 (step S9). When the grid cell update is completed, the flow returns to step S5.

As described above, by operating the grid cell display key and cross key in the grid mode, the user can set a desired number of grid cells into which the display area is divided and can move the selected grid cell to a desired position. This implements movement of the cursor in grid cells.

When the selected grid cell reaches the desired position, the user can return the operation mode to the normal mode by operating the pointing device shown in FIG. 1. More specifically, if it is determined in step S5 of FIG. 6 that the pointing device is operated, the grid cell information acquisition/storage section 119 stores the basic information of the grid cells at this time in the memory 108 (step S10), and the grid cell display section 116 supplies display data to erase the grid cells to the display data buffer 118 (step S11). Then, the mode of the portable information terminal shifts to the normal mode (step S12).

After the mode of the portable information terminal shifts to the normal mode, the user may move the cursor 125 to, e.g., a desired button, as indicated by an arrow B in FIG. 5, by operating the pointing device and may perform a click operation or the like. The moving range at this time is as narrow as or even narrower than about one grid cell. The cursor 125 moves sufficiently slowly and finely in response to an operation of the pointing device. For this reason, the user can reliably move the cursor 125 to, e.g., a button to be clicked.

As described above, in the portable information terminal according to this embodiment, rough movement in the grid mode and fine movement in the normal mode make it possible to move the cursor to a desired position quickly and precisely. The cross key or pointing device can be operated easily with one hand in these modes. The portable information terminal of this embodiment has excellent operability.

In the above explanation, a portable information terminal is described as an example of the electronic apparatus according to the present invention. However, the present invention may be applied to a mobile phone.

In the explanation, an apparatus with a touch panel is described as an example of the electronic apparatus according to the present invention. The touch panel, however, is not indispensable to the electronic apparatus of the present invention.

In the explanation, a cross key is described as an example of the direction key according to the present invention. However, the direction key of the present invention may be one of any other type.

In the explanation, a device which slides in an arbitrary direction within a plane parallel to the figure is described as an example of a pointing device according to the present invention. However, the pointing device of the present invention may be that having a ball installed in the keyboard which is operated by rotating the ball. Alternatively, the pointing device may be that having a stick installed in the keyboard which is operated by titling the stick. Alternatively, the pointing device may be that having a pad installed in the keyboard which is operated by rubbing its surface.

What is claimed is:

1. An electronic apparatus which displays an information screen and accepts input on the displayed information screen, comprising:
a display section which displays an information screen within a display area; and
an operation section in which a pointing device operable in an arbitrary direction and a plurality of direction keys respectively assigned a plurality of predetermined directions are installed, the pointing device moving an input position within the display area in a direction associated with an operation, the plurality of direction keys shifting a cell selected from among a plurality of cells, into which the display area is divided, in a direction associated with an operation among the plurality of predetermined directions and moving the input position into the selected cell shifted.

2. The electronic apparatus according to claim 1, wherein the plurality of direction keys are so arranged as to surround the pointing device.

3. The electronic apparatus according to claim 1, wherein a cell change operation member which changes the plurality of cells, into which the display area is divided, to a plurality of cells associated with an operation is also installed in the operation section.

4. An input control apparatus for performing input control in an electronic apparatus which displays an information screen and accepts input on the displayed information screen,
wherein the electronic apparatus comprises a display section which displays an information screen within a display area, and an operation section in which a pointing device operable in an arbitrary direction and a plurality of direction keys respectively assigned a plurality of predetermined directions are installed, and
the input control apparatus comprises
an input position control section which moves an input position within the display area in a direction associated with an operation of the pointing device, and
a selected cell control section which shifts a cell selected from among a plurality of cells, into which the display area is divided, in a direction associated with an operation of the direction key among the plurality of predetermined directions and moves the input position into the selected cell shifted.

5. The input control apparatus according to claim 4, wherein the plurality of direction keys are so arranged as to surround the pointing device.

6. The input control apparatus according to claim 4, wherein
a cell change operation member is also installed in the operation section, and
the input control apparatus further comprises a cell change control section which changes the plurality of cells, into which the display area is divided, to a plurality of cells associated with an operation of the cell change operation member.

7. An input control program storage medium storing an input control program executed by an electronic apparatus which displays an information screen and accepts input on the displayed information screen,
wherein the electronic apparatus comprises a display section which displays an information screen within a display area, and an operation section in which a pointing device operable in an arbitrary direction and a plurality of direction keys respectively assigned a plurality of predetermined directions are installed, and
the program constructs, on the electronic apparatus,
an input position control section which moves an input position within the display area in a direction associated with an operation of the pointing device, and
a selected cell control section which shifts a cell selected from among a plurality of cells, into which the display area is divided, in a direction associated with an operation of the direction key among the plurality of predetermined directions and moves the input position into the selected cell shifted.

8. The input control program storage medium according to claim 7, wherein the plurality of direction keys are so arranged as to surround the pointing device.

9. The input control program storage medium according to claim 7, wherein
a cell change operation member is also installed in the operation section, and
the program further constructs a cell change control section which changes the plurality of cells, into which the display area is divided, to a plurality of cells associated with an operation of the cell change operation member.

10. An input control method in an electronic apparatus which displays an information screen and accepts input on the displayed information screen,
wherein the electronic apparatus comprises a display section which displays an information screen within a display area, and an operation section in which a pointing device operable in an arbitrary direction and a plurality of direction keys respectively assigned a plurality of predetermined directions are installed, and
the method comprises
an input position control step of moving an input position within the display area in a direction associated with an operation of the pointing device, and
a selected cell control step of shifting a cell selected from among a plurality of cells, into which the display area is divided, in a direction associated with an operation of the direction key among the plurality of predetermined directions and moving the input position into the selected cell shifted.

11. The input control method according to claim 10, wherein the plurality of direction keys are so arranged as to surround the pointing device.

12. The input control method according to claim 10, wherein
a cell change operation member is also installed in the operation section, and
the method further comprises a cell change control step of changing the plurality of cells, into which the display area is divided, to a plurality of cells associated an operation of the cell change operation member.
